(19) United States
(12) Patent Application Publication
(10) Pub. No.: US 2009/0171908 A1
(43) Pub. Date: Jul. 2, 2009

(54) Natural language minimally explicit grammar pattern

(76) Inventors: Michael Patrick Nash, Saskatoon (CA); Ryan Scott Breidenbach, Coppell, TX (US); Roderick F. Coffin, III, Dallas, TX (US); Kelly Christopher Fox, Austin, TX (US); Ben Rady, Dallas, TX (US); Daniel L. James, Annetta, TX (US); Paul Randolph Holser, JR., Addison, TX (US); Ruby Bailey, McKinney, TX (US); Craig Walls, Plano, TX (US)

Correspondence Address: Steven Thrasher, 391 Sandhill Dr., Richardson, TX, 75080, US

(21) Appl. No.: 12/079,793

(22) Filed: Mar. 28, 2008

Related U.S. Application Data
(60) Provisional application No. 61/009,815, filed on Jan. 2, 2008.

(51) Int. Cl. G06F 17/30

(52) U.S. Cl. 707/3; 707/E17.015

(57) ABSTRACT

The invention utilizes a known syntax and concept model to enable a user to make a reliable and accurate database query with words that more closely resemble the user's natural language and less like a structured database query. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

The invention is related to and claims priority from pending U.S. Provisional Patent Application No. 61/009,815 to Lane, et al., entitled NATURAL LANGUAGE DATABASE QUERYING filed on 2 Jan. 2008.

### TECHNICAL FIELD OF THE INVENTION

The present invention relates generally to structured data querying, and more particularly to natural language database querying.

### Problem Statement

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Database querying is generally limited to structured queries. Recently, attempts have been made to generate “natural language” queries, however, these “solutions” involve a significant amount of menu-driven selecting of terms and relations to guide a user to ask the “right” question. This solution is burdensome, and entirely unsatisfactory to most users. The present invention solves the problem of time-consuming menu-driven database querying.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is an exemplary concept model.

FIG. 2 illustrates the Minimally Explicit Grammar Pattern (MEGP) syntax.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Computing platforms are computers, such as personal computers, workstations, servers, or sub-systems of any of the aforementioned devices. Further, a computing platform may be segmented by functionality into a first computing platform, second computing platform, etc. such that the physical hardware for the first and second computing platforms is identical (or shared), where the distinction between the devices (or systems and/or sub-systems, depending on context) is defined by the separate functionality which is typically implemented through different code (software).

Of course, the foregoing discussions and definitions are provided for clarification purposes and are not limiting. Words and phrases are to be given their ordinary plain meaning unless indicated otherwise.

### DESCRIPTION OF THE DRAWINGS

A minimally explicit grammar pattern (MEGP) is in one aspect a system for expressing what a user intends to find as the result of a database inquiry in an explicit way such that ambiguity is removed from the query. Stated another way, functionally, MEGP is a compromise between entering a true free-form natural language query, and having to either type a structured query and/or use a menu-driven query system. As a system, MEGP defines a syntax and set of words that are a subset of a user's natural language, and which map to known concepts, values, logical relationships, relations, and/or comparitors. This discussion incorporates the teachings of co-pending and co-owned U.S. patent application Ser. No. 11/______ to Lane, et al. filed on 31 Jan. 2008, entitled DOMAIN-SPECIFIC CONCEPT MODEL FOR ASSOCIATING STRUCTURED DATA THAT ENABLES A NATURAL LANGUAGE QUERY, which is incorporated herein by reference in its entirety. Of course, it is understood that those terms used herein are readily apparent and understood by those skilled in the art of conceptual databases upon reading this disclosure.

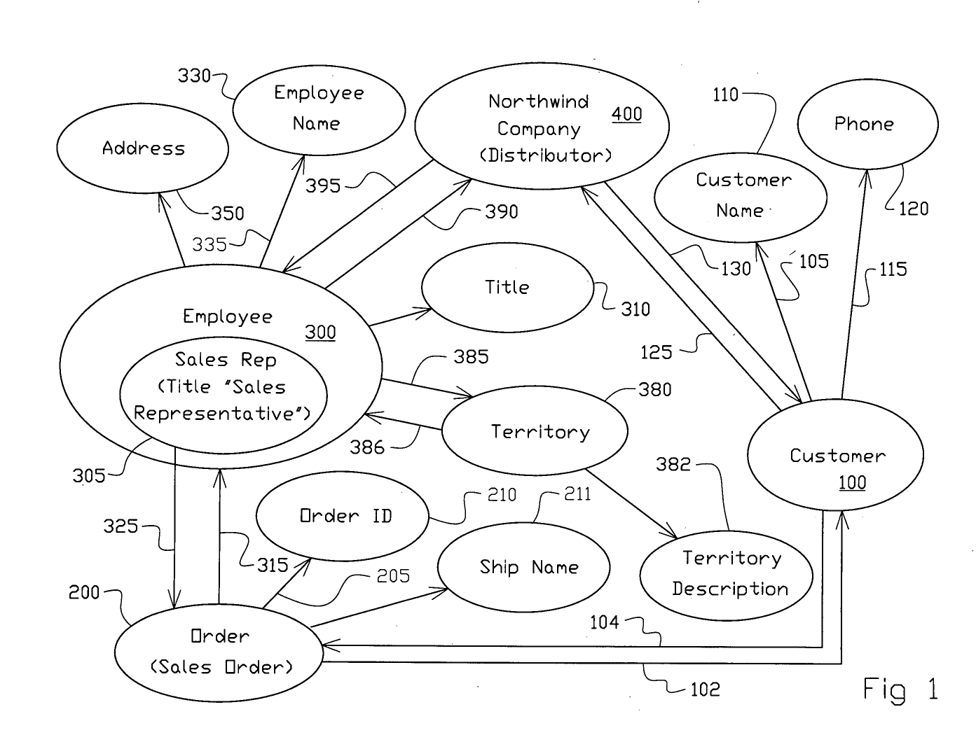

FIG. 1 is an exemplary concept model. The concept model comprises a customer concept 100, an order concept 200, a company concept 400, and an employee concept 300 that wholly includes a sales rep property 305. The customer concept 100 is related to property “customer name” 110 by relation “named” 105, and property phone 120 by relation “having phone” 115. Customer concept 100 is related to company concept 400 by the “buys from” relation and the “sells to” reverse relation, as well as the order concept 200 via the “who placed” relation 104 and the “placed by” 102 reverse relation. Order concept 200 is related to the “order ID” property 210 via the “having ID” relation 205. Further, the order concept 200 is related to both the employee concept 300 and the “sales rep” property 305 via the “written by” relation 315 and the “who wrote” reverse relation 325.

The employee concept 300 is related to the company concept 400 via an “employed by” relation 390 and an employs relation 395 (which is a reverse-relation of the “employed by” relation 390). In addition, the employee concept 300 includes an “employee name” property 330 related by a “having name” relation 335, and an address external abstraction 350 related by the “working at address” relation 355.

The employee concept 300 is further related to a territory attribute 380 via an “assigned to” relation 385 and a second “assigned to” reverse concept 386. The territory attribute 380 is further related to a “territory description” property 382 via a “named” relation 383.

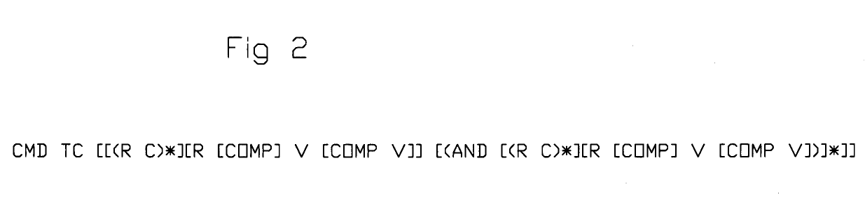

FIG. 2 illustrates the MEGP syntax. This syntax is part-and-parcel to a methodology of providing a user the ability to find specific data, without ambiguity, using a subset of that user's natural language in a subject area. In describing the methodology of entering a query using the MPEG syntax, reference is made to Table 1, below, which is a legend of the MPEG syntax nomenclature. It should be noted that the employment of synonyms is provided in the MEGP model, and the incorporation of synonyms is indicated in the following table as indicated by the “#” symbol.

TABLE 1
LEGEND OF MPEG SYNTAX NOMENCLATURE.

| ABBREVIATION/ | |
|---|---|
| SYMBOL | REPRESENTATION |
| CMD | Command. Example: “list”, “count”. # |
| TC | Target Concept. Single or multi-word; |
| | columns & rows returned for TC only. # |
| C | Concept. May be a Specialized Concept. # |
| V | Value. Exact match of one or more words (not |
| | case sensitive). |
| AND | The literal word “AND” or equivalent |
| | conjunction; not case sensitive. |
| R | Relation. Exact match of one or more words. |
| | Directionally unique for each concept. # |
| COMP | Comparitor. Ex) dates, “since”, “after”, |
| | “before”, “through”, “on”, “from/to”. < > =. # |
| [ ] | That which within is OPTIONAL. |
| * | Repeat. |

### General Methodology

Before discussing a specific MPEG, one should consider the invention from a “high”/generic level. One embodiment of the inventive method begins when a database query is begun when a computer system accepts an input comprising words (and, in some cases only words), where the input is restricted to a predefined syntax comprising a predefined set of words, in a known order, from a first known subject area, and an answer comprising a datum is generated in response to that database inquiry. The methodology preferably seeks to avoid returning “garbage” by validating that the input matches an expected structure before running any query on a target data source. Where a conceptual data model is employed, the method maps the words to a conceptual inquiry.

### More Specific MPEG Query Methodology

With more particular reference to FIG. 2, one embodiment of the invention can be recognized as a method for providing a user the ability to find specific data without ambiguity using a subset of that user's natural language in a subject area. Here, a user enters a search that locates structured data in a database, where the search “grammar” is predefined, here particularly to include mandatory elements comprising a command (such as “find”) and a target concept (such as “sales”), and a set of optional elements comprising at least either a relationship R (such as “exact match”) or a value V (such as ‘X’) having a comparitor such as “equal to ______.”

Accordingly, a command CMD may define an output type, such as “list”, “show”, “table” or “print.” The target concept TC is the first concept chosen, and is selected from a group of concepts, the group of concepts being predefined associations of sets of data. In addition, a relation R defines how a concept is related to either a value, comparitor or another concept. Thus, the relationship “R” is in one embodiment associated with a comparitor, or in other words, a relationship “R” is associated with a value “V” via a comparator. Similarly the value “V” may be associated directly with a comparitor (“equal to 1000”). Similarly, the comparitor may be associated with a second value “V.” Comparators may also define a mathematical, spatial, temporal, or logical relationship. The set of optional elements may include a second relationship “R” and a concept “C” related to the second relationship. Further, as is indicated by brackets “[ ]” in FIG. 2, the grammar may include additional optional elements and optional sets of elements, such as a second set of optional elements, or even a third relationship and a concept related to the third relationship. In the preferred embodiment, the second set of optional elements comprises a relationship and a concept.

### EXAMPLE 1

The following is an example of building a MEGP search on data accessible by the concept model of FIG. 1. Here, a user enters a MEGP search into the system: “list customers who placed orders written by employees assigned to territory named Texas.” The MEGP follows the concept model, so that a user who knows the MPEG grammar and syntax may flawlessly enter a search. Here, the command CMD “list” is followed by the target concept TC “customer(s).” Next, the user lists a relation R “who placed” followed by a concept C “order.” This R C pattern may be repeated as called for by the user within the confines of the then in-use concept model—for example, here the user enters another relation R “written by” and another concept C “employees.” The next relation R identifies that the employees are “assigned to” the abstract concept C “territory” having a relation R “named” to the property value V “Texas.” This is expressed in the inventive MEGP as CMD TC R C R C R C R V.

### EXAMPLE 2

This time, a user enters a MEGP search into the system: “list orders placed by customers named “Smith” AND written by employees having name Jones.” Again, the MEGP follows the concept model, so that a user who knows the MPEG grammar and syntax may flawlessly enter a search. Here, the command CMD “list” is followed by the target concept TC “orders” which is related by relation R “placed by” another concept “customers” having a relation R “named” to the value V “Smith” via the relation R “placed by”. Here, the user wants to establish an answer that is generated from two concepts that are treated independently as a user “traverses” the concept model—the “orders” and the “written by” concepts. Accordingly, the user joins these independent concepts by using a logical conjunction “AND.” Specifically, in this example, after entering the AND join, the user enters a new relation R “written by” concept “employees” having a relation R “named” to the value V “Jones”. This is expressed in the inventive MEGP as CMD TC R C R V AND R C R V.

### EXAMPLE 3

This time, a user enters a MEGP search into the system: “count employees who wrote orders valued at >999.” Again, the MEGP follows the concept model, so that a user who knows the MPEG grammar and syntax may flawlessly enter a search. Here, the command CMD “count” is followed by the target concept TC “employees” which is related by relation R “who wrote” to another concept “orders” having a comparitor COMP of “>” or its synonym “greater than” the value V “999.” This is expressed in the inventive MEGP as CMD TC R C R COMP V. As in the other two examples, the user is entering a search that is much more natural to the user than an SQL query.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method for providing a user the ability to find specific data without ambiguity using a subset of that user's natural language in a subject area, comprising:
accepting an input from a user, the input comprising words, and the input being restricted to a predefined syntax comprising a predefined set of words, in a known order, from a first known subject area;
the input being a database inquiry; and
generating an answer comprising a datum in response to the database inquiry.

2. The method of claim 1 further comprising validating that the input matches an expected structure.

3. The method of claim 1 further comprising mapping the words to a conceptual inquiry.

4. A method for providing a user the ability to find specific data without ambiguity using a subset of that user's natural language in a subject area, comprising:
a user entering a search that locates structured data in a database, comprising:
mandatory elements, comprising
a command, and
a target concept, and
an optional set of optional elements, comprising
a relationship, or
a value.

5. The method of claim 4 wherein the optional set of optional elements further comprises a comparitor.

6. The method of claim 5 wherein the value is associated with the comparitor.

7. The method of claim 6 wherein the comparitor is associated with a second value.

8. The method of claim 4 wherein the optional set of optional elements comprise a second relationship and a second concept related to the second relationship.

9. The method of claim 8 wherein the set of optional elements comprise a third relationship and a third concept related to the third relationship.

10. The method of claim 4 further comprising a second set of optional elements.

11. The method of claim 10 wherein the second set of optional elements comprises a relationship and a concept.

12. The method of claim 4 wherein the command is a “find” command.

13. The method of claim 4 wherein the target concept is a “sales” concept.

14. The method of claim 5 wherein the relationship is an “exact match” relationship.

15. The method of claim 5 wherein the comparator is “equal to.”

16. The method of claim 4 where the command defines an output type.

17. The method of claim 4 where the target concept is selected from a group of concepts, the group of concepts being predefined associations of sets of data.

18. The method of claim 4 where the relationship defines how a concept is related to either a value, comparitor or another concept.

19. The method of claim 5 where the comparitor defines a mathematical, spatial, temporal, or logical relationship.

20. The method of claim 10 further comprising a third set of optional elements.
